(19) United States
(12) Patent Application Publication
(10) Pub. No.: US 2012/0013563 A1
(43) Pub. Date: Jan. 19, 2012

(54) TOUCH INPUT DEVICE

(76) Inventors: Shih-Tzung Chou, Hsinchu (TW); Yong-Nien Rao, Hsinchu (TW); Zong-Lin Wu, Hsinchu (TW)

(21) Appl. No.: 12/834,961

(22) Filed: Jul. 13, 2010

(51) Int. Cl. G06F 3/041

(52) U.S. Cl. 345/174

(57) ABSTRACT

A touch input device is disclosed in this invention. The touch input device includes a touch panel, a selection module and a detection module. The touch panel includes capacitive nodes thereon. The selection module is electrically connected to the capacitive nodes of the touch panel. The selection module is used for selecting at least one capacitive node from the capacitive nodes respectively, in order to form a first capacitive node class and a second capacitive node class which is adjacent to the first capacitive node class. The detection module includes a signal generator for generating a detective pulse signal and a reversal pulse signal with a phase opposite to the detective pulse signal. The detective pulse signal and the reversal pulse signal are respectively imported to the first capacitive node class and the second capacitive node class through the selection module.

### BACKGROUND OF THE INVENTION

1. Field of the Invention

The invention relates to a touch input device and a touch sensor circuit, and more particularly to a touch input device and a touch sensor circuit capable of suppressing an EMI effect.

2. Description of the Prior Art

With the development of information technology, the electronic products become more diversified and humanized. For example, based on the touch panel or touch pad nowadays, user may simply operate the device or type some sentences with their finger or a touch pen, instead of using the mouse or keyboard to type in the traditional and inconvenient way.

There are a number of types of touch panel technology: resistive type, capacitive type, optical type and surface acoustic wave type. The resistive-typed touch panel mainly includes upper and lower ITO glass layers. When an object touches the upper ITO glass layer and presses it toward the lower ITO glass layer, the controller of the touch panel will generate a voltage signal, and coordinates of the contact point can be computed according to the voltage signal.

The capacitive-typed touch panel has two types: surface capacitive touch panel and projected capacitive touch panel. The surface capacitive touch panel includes a piece of conductive glass. Two surfaces of the conductive glass are coated with conductive material. External surfaces of the conductive glass are further coated with a protective film. The electrodes around the glass plate builds up an electric flied on the glass surfaces. When users touch the touch panel with their fingers, the fingers will be coupled to the capacitance on the glass surface and induce a small current. The controller of the touch panel may compute the coordinates of the contact point according to the current.

Recently, the projected capacitive touch panels are widely applied in various touch-input electronic devices (e.g. smart phones). The locating theory of the projected capacitive touch panel is based on the capacitive variation of the sensor grid implemented within the touch panel. Please refer to FIG. 1A, FIG. 1A is a schematic diagram illustrating a touch panel 10 in prior art. As shown in FIG. 1A, there are multiple X-directional conductive lines (X1˜Xm) and multiple Y-directional conductive lines (Y1˜Yn) disposed on different layers in the touch panel 10. The X-directional conductive lines and the Y-directional conductive lines are cross to form the sensor grid. Each cross point of one X-directional conductive line and Y-directional conductive line is one capacitive node (e.g. the capacitive nodes 100a, 100b and 100c in FIG. 1A). In this case of FIG. 1A, there are m*n capacitive nodes totally. The coupling relationship between finger and sensor grid may change the capacitance values of adjacent capacitive nodes. The detection circuit may compute the coordinate of the contact point according to the capacitive variation of the capacitive nodes on the sensor grid.

Please refer to FIG. 1B. FIG. 1B is a schematic diagram illustrating a touch input device 1 in prior art. The touch input device 1 includes a touch panel 10 and corresponding touch detection circuit as shown in FIG. 1B. The touch detection circuit may include a multiplexer 12, a controller circuit 120 and a detection module 14. In practical applications, the detection module 14 can be a capacitance measuring unit.

In practical applications, the controller circuit 120 may control the multiplexer 12 and utilize it to select a specific X-directional conductive line (X1˜Xm) and a specific Y-directional conductive line (Y1˜Yn), so as to select one specific capacitive node. For example, the multiplexer 12 may select X-directional conductive line X3 and Y-directional conductive line Y3 for corresponding to the capacitive node 100a. Then, the detection module 14 may generate a detective pulse signal Sdet, and the detective pulse signal Sdet is imported into the capacitive node 100a through the multiplexer 12. Then, the detection module 14 judges a touch detection state of the capacitive node 100a according to the signal feedback of the detective pulse signal Sdet imported into the capacitive node 100a.

The controller circuit 120 may also control the multiplexer 12 to select one X-directional conductive line or one Y-directional conductive line in sequence, so as to scan capacitive nodes in a row/column at a time. Please refer to FIG. 2, FIG. 2 is a time sequence diagram illustrating that the touch input device 1 generates the detective pulse signal Sdet for different capacitive nodes. As shown in FIG. 2, the detective pulse signal Sdet is imported to X-directional conductive lines X1, X2, X3, X4 and other X-directional conductive lines in sequence.

This detective pulse signal Sdet is usually a voltage or current signal with high-frequency periodic pulse. When the detection module 14 imports the high-frequency detective pulse signal to a specific capacitive node (such as the capacitive node 100a), the detective pulse signal may cause the electromagnetic interference (EMI) effect to other electronic components (e.g. liquid crystal display) around the touch panel 10, and it may also cause the EMI effect to surrounding capacitive nodes (such as the capacitive nodes 100b and 100c).

Besides, in order to elevate the touch-input preciseness on the touch panel, designers are trying to narrow down the misjudging error while detecting the touch input. On the other hand, to eliminate or prevent the EMI effect between different electronic components is necessary in modern electronic products, especially in the trend of reducing the product size.

Therefore, the invention discloses a touch input device and a touch sensor circuit, which is suitable for various touch input electronic system, so as to solve said problems.

### SUMMARY OF THE INVENTION

A scope of the invention is to provide a touch input device, which includes a touch panel, a selection module and a detection module.

According to an embodiment, the touch panel includes a plurality of capacitive nodes. The capacitive nodes are formed and spread on the touch panel. The selection module is electrically connected with the capacitive nodes of the touch panel. The selection module selects a first capacitive node class and a second capacitive node class from the capacitive nodes. The second capacitive node class is adjacent to the first capacitive node class. The detection module is electrically connected with the selection module. The detection module includes a signal generator used for generating a detective pulse signal. The detective pulse signal is imported into the first capacitive node class through the selection module. The detection module judges a touch detection state of the first capacitive node class according to the detective pulse signal imported into the first capacitive node class. In the meantime the signal generator generates a reversal pulse signal with a phase opposite to the detective pulse signal. The reversal pulse signal is imported into the second capacitive node class through the selection module.

Another scope of the invention is to provide a touch input device, which includes a touch panel, a selection module, a first detection module and a second detection module.

According to an embodiment, the touch panel includes a plurality of capacitive nodes. The capacitive nodes are formed and spread on the touch panel. The selection module is electrically connected with the capacitive nodes of the touch panel. The selection module selects a first capacitive node class and a second capacitive node class from the capacitive nodes. The second capacitive node class is adjacent to the first capacitive node class. The first detection module is electrically connected with the selection module. The first detection module includes a first signal generator used for generating a first detective pulse signal. The first detective pulse signal is imported into the first capacitive node class through the selection module. The first detection module judges a first touch detection state of the first capacitive node class according to the first detective pulse signal imported into the first capacitive node class. The second detection module is electrically connected with the selection module. The second detection module includes a second signal generator used for generating a second detective pulse signal. The second signal generator generates a second detective pulse signal with a phase opposite to the first detective pulse signal. The second detective pulse signal is imported into the second capacitive node class through the selection module. The second detection module judges a second touch detection state of the second capacitive node class according to the second detective pulse signal imported into the second capacitive node class.

The advantage and spirit of the invention may be understood by the following recitations together with the appended drawings.

### BRIEF DESCRIPTION OF THE APPENDED DRAWINGS

FIG. 1A is a schematic diagram illustrating a touch panel in prior art.

FIG. 1B is a schematic diagram illustrating a touch input device in prior art.

FIG. 2 is a time sequence diagram illustrating that the touch input device generates the detective pulse signal Sdet for different capacitive nodes.

FIG. 3 is a schematic diagram illustrating a touch input device according to a first embodiment of the invention.

FIG. 4A is a schematic diagram illustrating an operational example about how to select the first capacitive node class and the second capacitive node class.

FIG. 4B is a schematic diagram illustrating an operational example about how to select the first capacitive node class and the second capacitive node class.

FIG. 4C is a schematic diagram illustrating an operational example about how to select the first capacitive node class and the second capacitive node class.

FIG. 5 is a time sequence diagram illustrating that the touch input device generates the detective pulse signal and the reversal pulse signal to different capacitive node classes.

FIG. 6 is a schematic diagram illustrating a touch input device according to the second embodiment of the invention.

FIG. 7 is a time sequence diagram illustrating that the touch input device generates the first detective pulse signal and the second reversal pulse signal to different capacitive node classes.

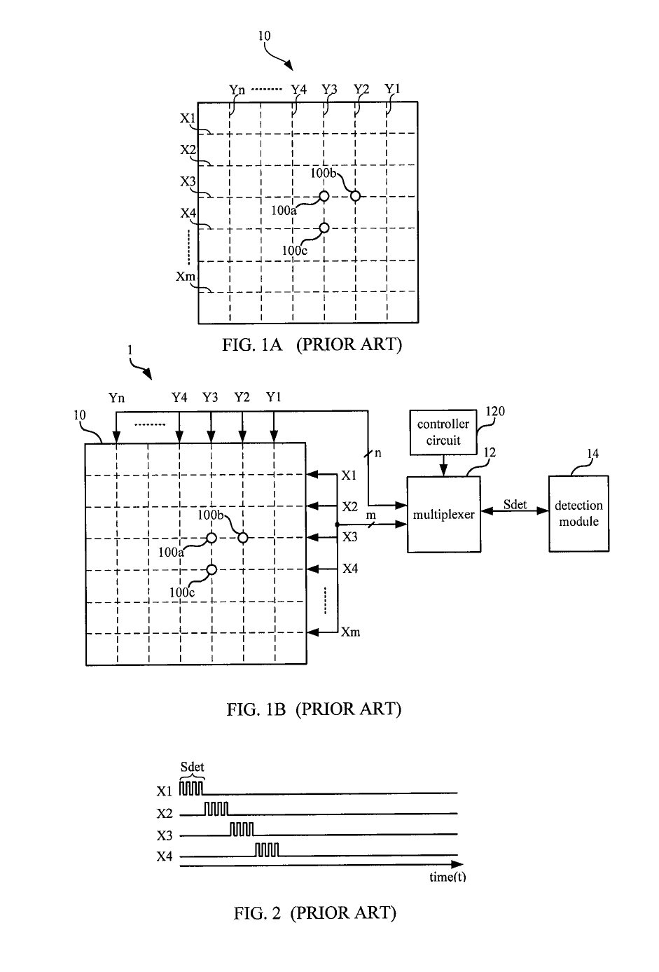

### DETAILED DESCRIPTION OF THE INVENTION

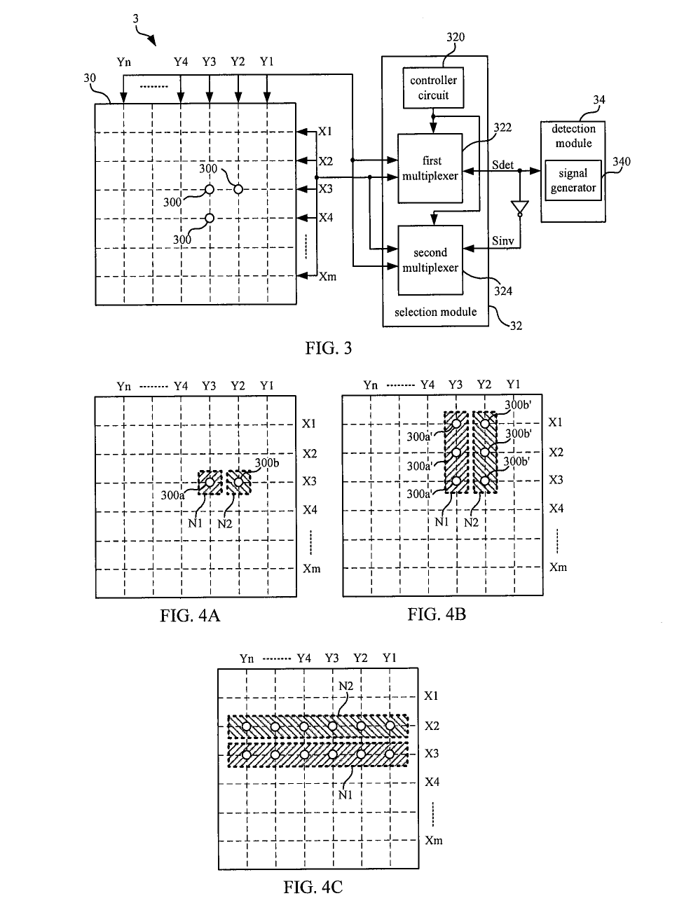

Please refer to FIG. 3. FIG. 3 is a schematic diagram illustrating a touch input device 3 according to a first embodiment of the invention. The touch input device 3 includes a touch panel 30, a selection module 32 and a detection module 34.

In this embodiment, the touch panel 30 includes a plurality of X-directional conductive lines (X1˜Xm) and a plurality of Y-directional conductive lines (Y1˜Yn). The X-directional conductive lines and the Y-directional conductive lines are arranged in a grid shape. As shown in FIG. 3, the X-directional conductive lines are disposed in parallel direction, and the Y-directional conductive lines are disposed in vertical direction, such that to form an intersectional grid shape. However, the invention is not limited to this kind of wiring arrangement. In other embodiment, the lines can be arranged into different direction or angle. Besides, there is one capacitive node formed on each intersectional point the X-directional conductive lines and one of the Y-directional conductive lines (please refer to capacitive nodes 300 in FIG. 3). In other words, the touch panel 30 includes a plurality of capacitive nodes formed and spread on the touch panel 30. The capacitive nodes correspond to one of the X-directional conductive lines and one of the Y-directional conductive lines respectively. In practical applications, the touch panel can be a projected capacitive touch panel or other equivalent capacitive touch panel.

As shown in FIG. 3, the selection module 32 is electrically connected with the capacitive nodes of the touch panel 30. The detection module 34 is electrically connected with the selection module 32.

In this embodiment, the selection module 32 further includes a first multiplexer 322 and a second multiplexer 324 and a controller circuit 320 for controlling aforesaid multiplexers. The first multiplexer 322 and the second multiplexer 324 are coupled between the touch panel 30 and the detection module 34. The first multiplexer 322 and the second multiplexer 324 are electrically connected with the X-directional conductive lines (X1˜Xm) and the Y-directional conductive lines (Y1˜Yn) respectively.

The selection module 32 utilizes the controller circuit 320 for controlling the first multiplexer 322 and the second multiplexer 324 to select a first capacitive node class and a second capacitive node class from all capacitive nodes on the touch panel 30. The first capacitive node class and a second capacitive node class here may include at least one capacitive node. Besides, the second capacitive node class selected by the second multiplexer 324 is designed to be adjacent to the first capacitive node class selected by the first multiplexer 322.

To be noticed that, the first capacitive node class and a second capacitive node class here may include at least one capacitive node. In practical applications, each capacitive node class may include one capacitive node, a plurality of neighboring capacitive nodes, capacitive nodes in a row or capacitive nodes in a column.

There are three operational examples about how to select the capacitive node classes listed in following paragraphs for demonstration.

Please refer to FIG. 4A, FIG. 4B and FIG. 4C. FIG. 4A to FIG. 4C are schematic diagrams illustrating three different operational examples about how to select the first capacitive node class N1 and the second capacitive node class N2.

As shown in FIG. 4A, the first capacitive node class N1 selected by the first multiplexer 322 may include one singular capacitive node 300a. On the other hand, the second capacitive node class N2 selected by the second multiplexer 324 may include one singular capacitive node 300b. In this case, first multiplexer 322 may select one X-directional conductive line (such as X3 in FIG. 4A) from the X-directional conductive lines and select one Y-directional conductive line (such as Y3 in FIG. 4A) from the Y-directional conductive lines, so as to select the capacitive node 300a for forming the first capacitive node class N1. On the other hand, the second multiplexer 324 may select one X-directional conductive line (such as X3 in FIG. 4A) from the X-directional conductive lines and select one Y-directional conductive line (such as Y2 in FIG. 4A) from the Y-directional conductive lines, so as to select the capacitive node 300b for forming the second capacitive node class N2.

As shown in FIG. 4B, the first capacitive node class N1 selected by the first multiplexer may include multiple capacitive nodes 300a′. On the other hand, the second capacitive node class N2 selected by the second multiplexer 324 may include multiple capacitive nodes 300b′. In this case, first multiplexer 322 may select at least one X-directional conductive line (such as X1˜X3 in FIG. 4B) from the X-directional conductive lines and select at least one Y-directional conductive line (such as Y3 in FIG. 4B) from the Y-directional conductive lines, so as to select at least one capacitive nodes 300a′ for forming the first capacitive node class N1. On the other hand, the second multiplexer 324 may select at least one X-directional conductive line (such as X1˜X3 in FIG. 4B) from the X-directional conductive lines and select at least one Y-directional conductive line (such as Y2 in FIG. 4B) from the Y-directional conductive lines, so as to select at least one capacitive nodes 300b′ for forming the second capacitive node class N2.

As shown in FIG. 4C, the first capacitive node class N1 selected by the first multiplexer may include capacitive nodes in a row or capacitive nodes in a column. On the other hand, the second capacitive node class N2 selected by the second multiplexer 324 may include capacitive nodes in a row or capacitive nodes in a column. In this case, first multiplexer selects a first X-directional conductive line (X3) from the X-directional conductive lines and make the Y-directional conductive lines (Y1˜Yn) grounded or floating, so as to select all capacitive nodes corresponding to the first X-directional conductive line (X3) for forming the first capacitive node class N1. In the meantime, the second multiplexer to selects a first X-directional conductive line (X2) from the X-directional conductive lines and make the Y-directional conductive lines (Y1˜Yn) grounded or floating, so as to select all capacitive nodes corresponding to the second X-directional conductive line (X2) for forming the second capacitive node class N2.

According to aforesaid embodiments, the selection way of forming capacitive node class includes selecting vertical/parallel adjacent nodes on one or multiple conductive lines. In other words, each capacitive node class may contain singular or multiple capacitive nodes arranged in parallel-adjacent, in round shape, in rectangular shape or in any equivalent pattern.

An operational example is shown in FIG. 4A and listed in the following paragraphs for demonstration. Please refer to FIG. 3 and FIG. 4A. As shown in FIG. 3, the detection module 34 includes a signal generator 340, which is used for generating a detective pulse signal Sdet. The detective pulse signal Sdet can be imported into the first capacitive node class N1 (as shown in FIG. 4A) through the first multiplexer 322 of the selection module 32. The detection module 34 may judge a touch detection state of the first capacitive node class N1 according to the detective pulse signal Sdet imported into the first capacitive node class N1.

For example, when users makes a contact on the location of the capacitive node 300a (i.e. the first capacitive node class N1), the capacitance value of the capacitive node 300a will vary. In this case, the detection module 34 may acknowledge the touch detection state of the first capacitive node class N1, according to a signal feedback of the detective pulse signal Sdet imported to the first capacitive node class. The signal feedback corresponds to a capacitance variation of the first capacitive node class N1.

To be noticed that, while the signal generator 340 generating the detective pulse signal Sdet to the first capacitive node class N1, the signal generator 340 generates a reversal pulse signal Sinv with a phase opposite to the detective pulse signal Sdev in the meantime. In the embodiment shown in FIG. 3, the reversal pulse signal Sinv can be generated by applying a simple inverter circuit after the detective pulse signal Sdev, but the invention is not limited to this. In another embodiment, it may implement a pair of synchronized and opposite-phased signal generators for generating two pulse signals respectively. Or in other cases, two pulse signals can be generated by other phase adjusting circuit, which is well-known by person in the art. To be noticed that, the reversal pulse signal Sinv is imported into the second capacitive node class N2 near the first capacitive node class N1 through the selection module 32.

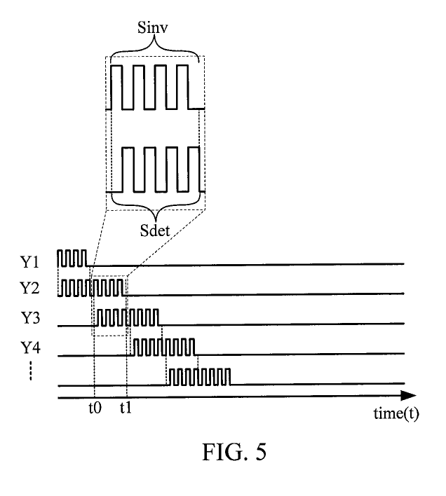

Please refer to FIG. 5. FIG. 5 is a time sequence diagram illustrating that the touch input device 3 generates the detective pulse signal Sdev and the reversal pulse signal Sinv to different capacitive node classes. As shown in FIG. 5, during one detection period (i.e. from time spot t0 to time spot t1 in FIG. 5), the detection module 34 generates the detective pulse signal Sdev and the reversal pulse signal Sinv, and then the detection module 34 imports the detective pulse signal Sdev and the reversal pulse signal Sinv into two adjacent capacitive node classes. In this way, the detective pulse signal Sdev can be used in judging the touch detection state of capacitive nodes. In the meantime, the reversal pulse signal Sinv may suppress an Electromagnetic radiation interference effect caused by the detective pulse signal Sdev to surrounding electronic components. Besides, the reversal pulse signal Sinv may also suppress an Electromagnetic conduction interference effect caused by the detective pulse signal Sdev to other conductive nodes.

In summary, the touch input device 3 generates the reversal pulse signal Sinv with the phase opposite to the detective pulse signal Sdev, and imports the reversal pulse signal Sinv to capacitive nodes around the target capacitive node class, so as to suppress the EMI effect, but the invention is not limited to this.

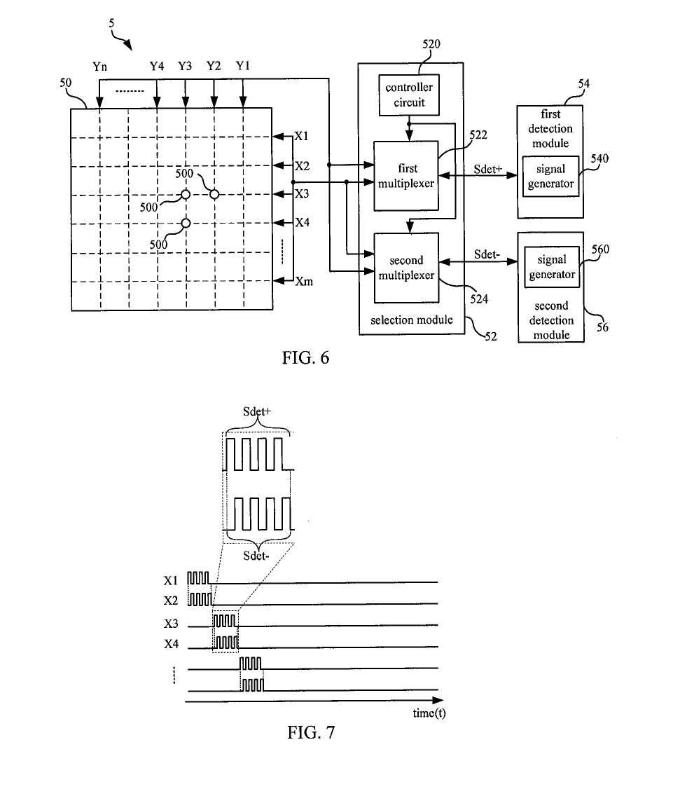

Please refer to FIG. 6. FIG. 6 is a schematic diagram illustrating a touch input device 5 according to the second embodiment of the invention. The main difference from the first embodiment is that, the touch input device 5 in the second embodiment includes two detection modules, such as the first detection module 54 and the second detection module 56.

In this embodiment, the first detection module 54 and the second detection module 56 includes their own signal generators (540, 560) for generating a first detective pulse signal Sdet+ and a second detective pulse signal Sdet−. The first detective pulse signal Sdet+ is imported into the first capacitive node class through the selection module 52, for judging a first touch detection state of the first capacitive node class. On the other hand, the second detective pulse signal Sdet− is imported into the second capacitive node class through the selection module 52, for judging a second touch detection state of the second capacitive node class.

To be noticed that, the first detective pulse signal Sdet+ and the second detective pulse signal Sdet− have opposite phases. In other words, the first detective pulse signal Sdet+ and the second detective pulse signal Sdet− may suppress the EMI effect caused by the other, so as to elevate the system stability. Besides, the first detection module 54 and the second detection module 56 may judge the touch detection state of two capacitive node classes according to the first detective pulse signal Sdet+ and the second detective pulse signal Sdet− at the same time. Theoretically, the judgmental speed of touch input detection can be speeded up two times as faster as original speed in prior art. Please refer to FIG. 7. FIG. 7 is a time sequence diagram illustrating that the touch input device 5 generates the first detective pulse signal Sdev+ and the second reversal pulse signal Sdet- to different capacitive node classes.

In the example shown in FIG. 7, the first detection module 54 imports the first detective pulse signal Sdev+ to the X-directional conductive line X3, and makes all Y-directional conductive lines (Y1˜Yn) grounded or floating, so as to select all capacitive nodes corresponding to the X-directional conductive line X3 for forming the first capacitive node class N1. In this case, the detection is performed onto the nodes with range of (X3, Y1˜Yn). On the other hand, the second detection module 56 imports the second detective pulse signal Sdev− to the X-directional conductive line X4, and makes all Y-directional conductive lines (Y1˜Yn) grounded or floating, so as to select all capacitive nodes corresponding to the X-directional conductive line X4 for forming the second capacitive node class N4. In this case, the detection is performed onto the nodes with range of (X4, Y1˜Yn).

According to aforesaid embodiments, the selection way of forming capacitive node class in the touch input device 5 of the invention is not limited to select vertical/parallel adjacent nodes. In another embodiment, each capacitive node class may contain singular or multiple capacitive nodes arranged in parallel-adjacent, in round shape, in rectangular shape or in any equivalent pattern. Besides, the total amount of capacitive nodes is not limited to two in one capacitive node class. One class may contain more than one capacitive node to achieve the equivalent or even faster detection speed. The other components and detail operational theory of the touch input device 5 in the second embodiment is substantially similar to the first embodiment, so not to be repeated here again.

Compared with prior art, the invention imports a pair of synchronic and opposite-phased pulse signal to adjacent capacitive nodes or adjacent capacitive node classes, so as to perform the touch detection. The opposite-phased pulse signals may reduce the EMI effect to other electronic components in the whole system, and elevate the stability of the touch input device.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch input device, comprising:
a touch panel comprising:
a plurality of capacitive nodes formed and spread on the touch panel;
a selection module electrically connected with the capacitive nodes of the touch panel, the selection module selecting a first capacitive node class and a second capacitive node class from the capacitive nodes, the second capacitive node class being adjacent to the first capacitive node class; and
a detection module electrically connected with the selection module, the detection module comprising a signal generator used for generating a detective pulse signal, the detective pulse signal being imported into the first capacitive node class through the selection module, the detection module judging a touch detection state of the first capacitive node class according to the detective pulse signal imported into the first capacitive node class, and in the meantime the signal generator generating a reversal pulse signal with a phase opposite to the detective pulse signal, the reversal pulse signal being imported into the second capacitive node class through the selection module.

2. The touch input device of claim 1, wherein the touch panel is a projected capacitive touch panel.

3. The touch input device of claim 1, wherein the touch panel comprises a plurality of X-directional conductive lines and a plurality of Y-directional conductive lines, the X-directional conductive lines and the Y-directional conductive lines are arranged in a grid shape, and each of the capacitive nodes is formed corresponding to one of the X-directional conductive lines and one of the Y-directional conductive lines.

4. The touch input device of claim 3, wherein the selection module comprises:
a first multiplexer coupled between the touch panel and the detection module, the first multiplexer being electrically connected with the X-directional conductive lines and the Y-directional conductive lines, the selection module utilizing the first multiplexer to select one X-directional conductive line from the X-directional conductive lines and select one Y-directional conductive line from the Y-directional conductive lines, so as to select one capacitive node of the capacitive nodes on the touch panel for forming the first capacitive node class; and
a second multiplexer coupled between the touch panel and the detection module, the second multiplexer being electrically connected with the X-directional conductive lines and the Y-directional conductive lines, the selection module utilizing the second multiplexer to select one X-directional conductive line from the X-directional conductive lines and select one Y-directional conductive line from the Y-directional conductive lines, so as to select one capacitive node of the capacitive nodes on the touch panel for forming the second capacitive node class.

5. The touch input device of claim 3, wherein the selection module comprises:
a first multiplexer coupled between the touch panel and the detection module, the first multiplexer being electrically connected with the X-directional conductive lines and the Y-directional conductive lines, the selection module utilizing the first multiplexer to select at least one X-directional conductive line from the X-directional conductive lines and select at least one Y-directional conductive line from the Y-directional conductive lines, so as to select at least one capacitive node of the capacitive nodes on the touch panel for forming the first capacitive node class; and
a second multiplexer coupled between the touch panel and the detection module, the second multiplexer being electrically connected with the X-directional conductive lines and the Y-directional conductive lines, the selection module utilizing the second multiplexer to select at least one X-directional conductive line from the X-directional conductive lines and select at least one Y-directional conductive line from the Y-directional conductive lines, so as to select at least one capacitive node of the capacitive nodes on the touch panel for forming the second capacitive node class.

6. The touch input device of claim 3, wherein the selection module comprises:
a first multiplexer coupled between the touch panel and the detection module, the first multiplexer being electrically connected with the X-directional conductive lines and the Y-directional conductive lines, the selection module utilizing the first multiplexer to select a first X-directional conductive line from the X-directional conductive lines and make the Y-directional conductive lines grounded or floating, so as to select all capacitive nodes corresponding to the first X-directional conductive line for forming the first capacitive node class; and
a second multiplexer coupled between the touch panel and the detection module, the second multiplexer being electrically connected with the X-directional conductive lines and the Y-directional conductive lines, the selection module utilizing the second multiplexer to select a first X-directional conductive line from the X-directional conductive lines and make the Y-directional conductive lines grounded or floating, so as to select all capacitive nodes corresponding to the second X-directional conductive line for forming the second capacitive node class.

7. The touch input device of claim 3, wherein the selection module comprises:
a first multiplexer coupled between the touch panel and the detection module, the first multiplexer being electrically connected with the X-directional conductive lines and the Y-directional conductive lines, the selection module utilizing the first multiplexer to select a first Y-directional conductive line from the Y-directional conductive lines and make the X-directional conductive lines grounded or floating, so as to select all capacitive nodes corresponding to the first Y-directional conductive line for forming the first capacitive node class; and
a second multiplexer coupled between the touch panel and the detection module, the second multiplexer being electrically connected with the X-directional conductive lines and the Y-directional conductive lines, the selection module utilizing the second multiplexer to select a first Y-directional conductive line from the Y-directional conductive lines and make the X-directional conductive lines grounded or floating, so as to select all capacitive nodes corresponding to the second Y-directional conductive line for forming the second capacitive node class.

8. The touch input device of claim 1, wherein the detection module judges the touch detection state of the first capacitive node class according to a signal feedback of the detective pulse signal imported to the first capacitive node class, and the signal feedback corresponds to a capacitance variation of the first capacitive node class.

9. A touch input device, comprising:
a touch panel comprising:
a plurality of capacitive nodes formed and spread on the touch panel;
a selection module electrically connected with the capacitive nodes of the touch panel, the selection module selecting a first capacitive node class and a second capacitive node class from the capacitive nodes, the second capacitive node class being adjacent to the first capacitive node class; and
a first detection module electrically connected with the selection module, the first detection module comprising a first signal generator used for generating a first detective pulse signal, the first detective pulse signal being imported into the first capacitive node class through the selection module, the first detection module judging a first touch detection state of the first capacitive node class according to the first detective pulse signal imported into the first capacitive node class; and
a second detection module electrically connected with the selection module, the second detection module comprising a second signal generator used for generating a second detective pulse signal, the second signal generator generating a second detective pulse signal with a phase opposite to the first detective pulse signal, the second detective pulse signal being imported into the second capacitive node class through the selection module, the second detection module judging a second touch detection state of the second capacitive node class according to the second detective pulse signal imported into the second capacitive node class.

10. The touch input device of claim 9, wherein the touch panel is a projected capacitive touch panel.

11. The touch input device of claim 9, wherein the touch panel comprises a plurality of X-directional conductive lines and a plurality of Y-directional conductive lines, the X-directional conductive lines and the Y-directional conductive lines are arranged in a grid shape, and each of the capacitive nodes is formed corresponding to one of the X-directional conductive lines and one of the Y-directional conductive lines.

12. The touch input device of claim 11, wherein the selection module comprises:
a first multiplexer coupled between the touch panel and the first detection module, the first multiplexer being electrically connected with the X-directional conductive lines and the Y-directional conductive lines, the selection module utilizing the first multiplexer to select one X-directional conductive line from the X-directional conductive lines and select one Y-directional conductive line from the Y-directional conductive lines, so as to select one capacitive node of the capacitive nodes on the touch panel for forming the first capacitive node class; and
a second multiplexer coupled between the touch panel and the second detection module, the second multiplexer being electrically connected with the X-directional conductive lines and the Y-directional conductive lines, the selection module utilizing the second multiplexer to select one X-directional conductive line from the X-directional conductive lines and select one Y-directional conductive line from the Y-directional conductive lines, so as to select one capacitive node of the capacitive nodes on the touch panel for forming the second capacitive node class.

13. The touch input device of claim 11, wherein the selection module comprises:
a first multiplexer coupled between the touch panel and the first detection module, the first multiplexer being electrically connected with the X-directional conductive lines and the Y-directional conductive lines, the selection module utilizing the first multiplexer to select at least one X-directional conductive line from the X-directional conductive lines and select at least one Y-directional conductive line from the Y-directional conductive lines, so as to select at least one capacitive node of the capacitive nodes on the touch panel for forming the first capacitive node class; and
a second multiplexer coupled between the touch panel and the second detection module, the second multiplexer being electrically connected with the X-directional conductive lines and the Y-directional conductive lines, the selection module utilizing the second multiplexer to select at least one X-directional conductive line from the X-directional conductive lines and select at least one Y-directional conductive line from the Y-directional conductive lines, so as to select at least one capacitive node of the capacitive nodes on the touch panel for forming the second capacitive node class.

14. The touch input device of claim 11, wherein the selection module comprises:
a first multiplexer coupled between the touch panel and the first detection module, the first multiplexer being electrically connected with the X-directional conductive lines and the Y-directional conductive lines, the selection module utilizing the first multiplexer to select a first X-directional conductive line from the X-directional conductive lines and make the Y-directional conductive lines grounded or floating, so as to select all capacitive nodes corresponding to the first X-directional conductive line for forming the first capacitive node class; and
a second multiplexer coupled between the touch panel and the second detection module, the second multiplexer being electrically connected with the X-directional conductive lines and the Y-directional conductive lines, the selection module utilizing the second multiplexer to select a first X-directional conductive line from the X-directional conductive lines and make the Y-directional conductive lines grounded or floating, so as to select all capacitive nodes corresponding to the second X-directional conductive line for forming the second capacitive node class.

15. The touch input device of claim 11, wherein the selection module comprises:
a first multiplexer coupled between the touch panel and the first detection module, the first multiplexer being electrically connected with the X-directional conductive lines and the Y-directional conductive lines, the selection module utilizing the first multiplexer to select a first Y-directional conductive line from the Y-directional conductive lines and make the X-directional conductive lines grounded or floating, so as to select all capacitive nodes corresponding to the first Y-directional conductive line for forming the first capacitive node class; and
a second multiplexer coupled between the touch panel and the second detection module, the second multiplexer being electrically connected with the X-directional conductive lines and the Y-directional conductive lines, the selection module utilizing the second multiplexer to select a first Y-directional conductive line from the Y-directional conductive lines and make the X-directional conductive lines grounded or floating, so as to select all capacitive nodes corresponding to the second Y-directional conductive line for forming the second capacitive node class.

16. The touch input device of claim 9, wherein the first detection module judges the first touch detection state of the first capacitive node class according to a signal feedback of the first detective pulse signal imported to the first capacitive node class, and the signal feedback corresponds to a capacitance variation of the first capacitive node class.

17. The touch input device of claim 9, wherein the second detection module judges the second touch detection state of the second capacitive node class according to a signal feedback of the second detective pulse signal imported to the second capacitive node class, and the signal feedback corresponds to a capacitance variation of the second capacitive node class.
